(19) United States
(12) Patent Application Publication
(10) Pub. No.: US 2012/0192105 A1
(43) Pub. Date: Jul. 26, 2012

(54) DYNAMIC LEVEL OF DETAIL

(75) Inventors: Rasmus Groth, Copenhagen NV (DK); Asbjoern Sloth Toennesen, Broenshoej (DK); Manolo Oliver Folcarelli, Copenhagen V (DK); Jonas Tesch Hallberg, Copenhagen N (DK); Joshua Sills Gottdenker, Copenhagen K (DK); Tor Kristensen, Copenhagen NV (DK); Clifford Lee Hall, Jonesborough, TN (US)

(73) Assignee: LILA APS (AHEAD), COPENHAGEN N (DK)

(21) Appl. No.: 13/131,562

(22) PCT Filed: Nov. 27, 2009
(86) PCT No.: PCT/US09/66028

§ 371 Date: Aug. 15, 2011

Related U.S. Application Data
(60) Provisional application No. 61/118,121, filed on Nov. 26, 2008.

(51) Int. Cl. G06F 3/048

(52) U.S. Cl. 715/800

(57) ABSTRACT

A system and method of interfacing Levels of Detail (“LoD” being a means for providing access to progressively more detailed information of a three dimensional model or scene) with User Interface Components (UICs), and is related to companion applications filed simultaneously, all of which are part and parcel of a method for browsing digital content and composing digital media and data via dynamic interaction of tiled images, external video, audio, text, and/or multimedia resources to create smoother and faster response time to user request, managed by a level of detail system which expands the ability of the user to create, manipulate, and/or interact with digital content and/or media via an application hosted in a browser or running on a desktop application which enhances the user ability to dynamically position and zoom into and out of views within a larger canvas.

### RELATED APPLICATIONS

The instant application is related to and claims priority from U.S. Provisional Application 61/118,121, filed Nov. 26, 2008, titled Content-Context Browser and is also related to application titled “Dynamic Image Tiling” and application titled “Dynamic Network Browser,” each filed on the same date, to the same inventors, and all of which are hereby incorporated by reference herein in their entirety.

### BACKGROUND

One or more embodiments of the present invention relate to a system and method of interfacing Levels of Detail (LoD) with User Interface Components (UICs), and is related to companion applications filed simultaneously, all of which are part and parcel of a method for browsing digital content and composing digital media and data via dynamic interaction of tiled images, external video, audio, text, and/or multimedia resources to create smoother and faster response time to user request, managed by a level of detail system which expands the ability of the user to create, manipulate, and/or interact with digital content and/or media via an application hosted in a browser or running on a desktop application which enhances the user ability to dynamically position and zoom into and out of views within a larger canvas.

The concept of “Levels of Detail” (LoD) is known as a means for providing access to progressively more detailed information of a three dimensional (3D) model or scene.

In the software application development process, developers associate non-visual data sources and logic with visual UICs. Users of the system then interact with these UICs, e.g., by use of a user input device such as a mouse, keyboard, touchscreen, etc., in order to manipulate the non-visual data sources.

In the environment provided by at least one embodiment according to the invention, a plurality of virtual layers provides a challenge to the visual appearance of objects, such as interactive objects like menus. This is important to those developing applications to the environment provided by the embodiment.

Term List
Application—A computer software program comprising a set of executable or interpretable instructions for execution or interpretation by a processor.
API—Application Programming Interface—A documented way for developers to write software that works with a given application.
Client—An application which runs on a user's computer and occasionally communicates with one or more servers or other clients via an internet connection.
Server—An application that responds to requests from individual clients, interacting with a database to store and retrieve information on behalf of the client as needed. A server application may also facilitate communication between clients.

### SUMMARY

An object of one or more embodiments of the invention is to provide a control of objects at different zoom levels of the frame. An implementation of LoD as a fundamental property of User Interface Components (UICs) is not believed by the inventors to be known in the art.

Implementation is achieved by a method for providing at least one user interface component in a graphical user interface (GUI) at a plurality of zoom depth levels by associating a level of detail with at least one user interface control. Thereby, a user interface component is resizeable and/or repositionable to fit a given dimension.

One embodiment allows software developers to define not only the standard geometry and associated data for display of the UIC on a screen, but also to define a list of UICs that are paired with a Level of Detail (LoD) object. An application according to an embodiment comprises functionality for resizing and/or repositioning a UIC to a given dimension and, in certain additional embodiments, automatically select the correct UIC to be displayed. In at least some embodiments, the application comprises functionality for broadcasting messages of interest to UICs. The broadcast messages allow the selective or global setting of Levels of Detail for a receiving UIC, thereby providing automatic selection of the LoD appropriate for a display dimension, or to cause supporting UICs to transition to a specific LoD.

One embodiment also allows the application to set the LoD either by specific reference to an identifier associated with a LoD, or by a real normal value (0>n>1) where 0 is the minimal and 1 the maximal Level of Detail supported by the UIC.

In one embodiment of the invention, a LoD library is implemented in ActionScript 3.0, but other programming languages may be used without departing from the scope of the embodiments, e.g., a structurally complete programming language may be used.

### BRIEF DESCRIPTION OF THE DRAWINGS

FIG. 1 depicts the LoD System Hierarchy of Objects,

FIG. 2-6 are screenshots of different level of details objects associated with a space,

FIG. 7 is a flowchart depicting interaction between LoD System Objects, and

FIG. 8 is a block diagram of a computer system usable in conjunction with an embodiment.

### DETAILED DESCRIPTION

### Level of Detail (LoD) System Implementation

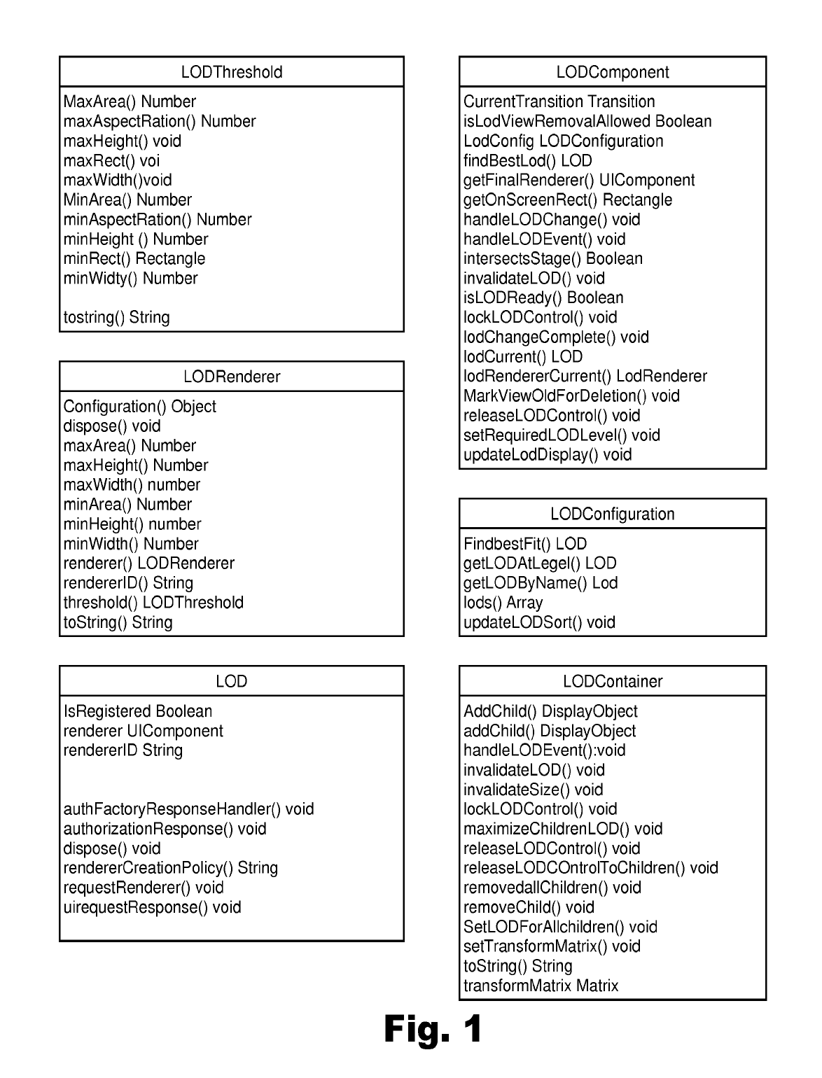

FIG. 1, “LoD Hierarchy,” is a flow chart depicting the relationship between the object types which comprise the LoD System.

The Level of Detail system comprises six unique object types.

LODConfiguration

An LODConfiguration (705) is a Dictionary, Object, or Hash table that stores an Array of LOD objects, and provides access to the stored LOD information by numeric index, or textual identifier. LODConfiguration (705) objects map the current or expected geometric dimensions of a visible object to an LOD object. This configuration may be applied to an entire document and shared by all LOD objects, or assigned to individual objects.

The UI components defined by this configuration may be standard UI components, LODComponents, or LODContainers (704).

LOD Object

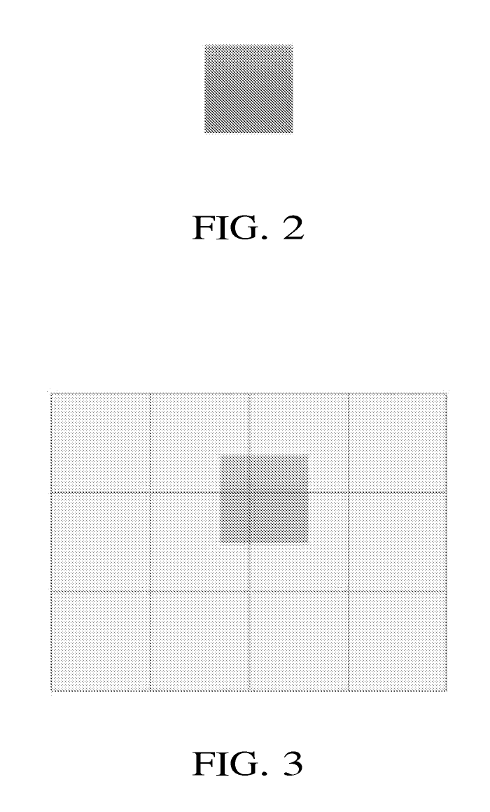

An LOD object associates a textual identifier, a LODThreshold (706), and a LODRenderer (708) definition. LOD objects are used to describe the class of UI component to be displayed to represent data whose on screen dimensions fall within the boundaries defined by the LODThreshold (706). For example, according to a given scenario if the displayed dimensions of a UIC fall below a predetermined LODThreshold (706) value, the UIC is not displayed and a specified UI component is displayed in place of the UIC. In at least some embodiments, the LODThreshold (706) specifies a range of values within which the dimensions must fall in order for the specified UI component to be displayed. In FIG. 2, a generic Level of Detail library has been loaded, and is rendering a specific document. At the displayed level of detail in this figure, only the topmost node of the document is visible, and is displayed at the minimum Level of Detail, in this case a blue rectangle.

LODThreshold (706)

In at least some embodiments, the LODThreshold (706) represents a geometric criteria defined by a minimum and maximum Rectangle. The LODThreshold (706) stores the minimum and maximum criteria for surface area, aspect ratio, width, and/or height for UI components on screen. In at least some embodiments, the LODThreshold (706) represents a shape other than rectangular, e.g., circular, elliptical, polygonal, etc. In at least some other embodiments, the LODThreshold (706) stores a single threshold criteria value.

LODRenderer (708)

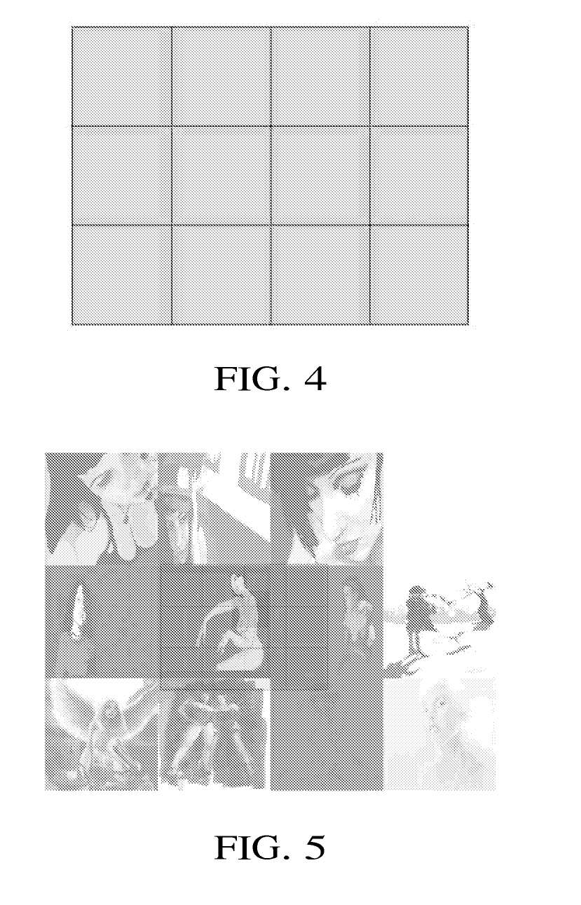

The LODRenderer (708) is an object that communicates with a host application in order to request the correct visual component, i.e., the specified UI component, for representation of associated data at a specific visual size. LODRenderer (708) objects also control the transition between different visual components as the components are made available by the host application. A host application is any application or module comprising functionality to create a tree (709) of LOD Library objects, communicate geometric changes made to the display to the LOD Library objects, and/or authorize requests (703) for visual components from the tree of LODComponents (709). In FIG. 3, the user has zoomed the viewport in by manipulation of an input device. The change in zoom level has begun a transition to a new level of detail. At the new Level of Detail, the topmost node will be removed, and child document nodes will be displayed. This figure illustrates the crossfading transition at a halfway point between the old and new visual components for the old and new levels of detail. In FIG. 4, the crossfading transition has completed, and the document is now displayed on screen using the new visual components that were assigned when the Level of Detail was changed as a result of user manipulation of the viewport.

The LODRenderer (708) supports synchronous and/or asynchronous messaging patterns for requesting and displaying UI components. The LODRenderer (708) also implements token-based authentication for the assignment of new UI views, so that the hosting application evaluates the requests for new UI components for authenticity, and thus prevents exploitation of the host application by dynamically loaded code which may or may not come from trusted sources.

LODRenderer (708) objects support different UI component creation policies, allowing the system to decide whether a component retains previously used LODRenderer (708) UI components in memory for reuse. In at least some embodiments, the rendered UI components are either standard UI components, LODComponents (709), or LODContainers (704) and therefore the resulting UI functionality supports objects that:

1. switch between standard UI components
icon>button>list>detailed grid
   In the example above, the LODRenderer (708) transitions from an icon, to an interactive button, to a list summary, to a detailed summary as the Level of Detail is increased; and/or
   2. switch from standard UI components to LOD enabled components or containers
icon>detailed image>LODContainer
   In the example above, the LODRenderer (708) transitions from an icon, to a detailed image, to a LODContainer (704) which automatically instances and renders a new tree of LOD enabled child objects.

LODContainer (704)

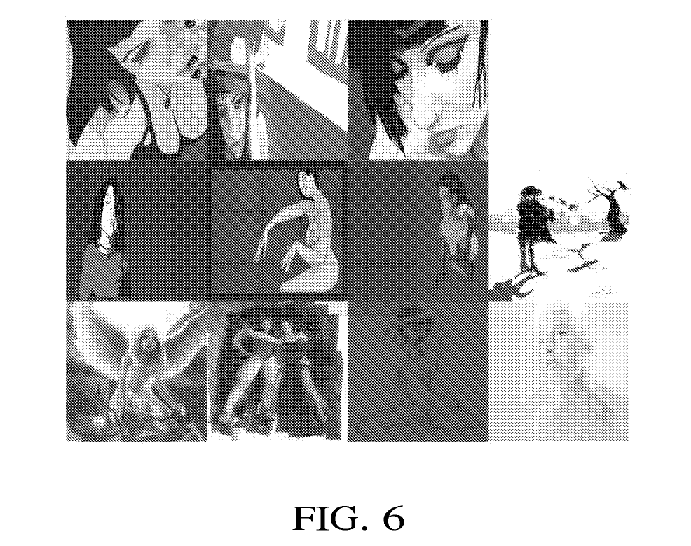

The LODContainer (704) is a top-level container, and comprises a mix of LOD-enabled and/or standard UI components. As the user manipulates and zooms the view of the visual components, e.g., by the manipulation of a user input device, the LODContainer (704) manages the synchronization of LOD levels and individual child object visibility. The LODContainer (704) also determines child components visibility, and transmits messages that inform the child objects (709) of their current zoom level, and whether the child objects (709) need to update or request new visual representations as a consequence of user manipulation of the view. In FIG. 5, the user has zoomed the viewport in by manipulation of an input device. The change in zoom level has begun a transition to a new level of detail. At the new Level of Detail, the currently visible nodes transition from grey rectangles to visual components capable of displaying bitmap image data. This figure illustrates the crossfading transition at a halfway point between the old and new visual components for the old and new levels of detail. In FIG. 6, the crossfading transition has completed, and the document is now displayed on screen using the new visual components that were assigned when the Level of Detail was changed as a result of user manipulation of the viewport.

The LODContainer (704) also comprises functionality for locking and unlocking some or all of the children into explicit Levels of Detail. This is achieved by calling the releaseLODControl( ) or lockLockLODControl( ) methods of child LODComponents. Locked LODComponent (709) objects ignore requests to reevaluate their current level of detail. The LODContainer (704) assigns a specific level of detail to child objects by calling the setRequiredLODLevel(n:Number) method of child objects. When assigning an explicit requiredLODLevel, n is a normal number value (0>n>1), where 0 is the lowest defined level of detail, and 1 is the highest level of detail available to the target LODComponent (709).

LODComponent (709)

LODComponent objects comprise the core logic functionality to request and transition between visual LODRenderer (708) (UI) components based on the current or projected geometry of the LODComponent (709) and the criteria and LODRenderer (708) associations defined in the LODConfiguration (705).

The LODComponent (709) assigns DOM data to each LODRenderer (708) as it becomes ready, so that each renderer displays a new view onto the same data structure.

The LODComponent (709) also allows the system to lock or unlock the current LOD level, thus enabling or disabling the individual components' ability to change the LOD state.

Runtime Narrative

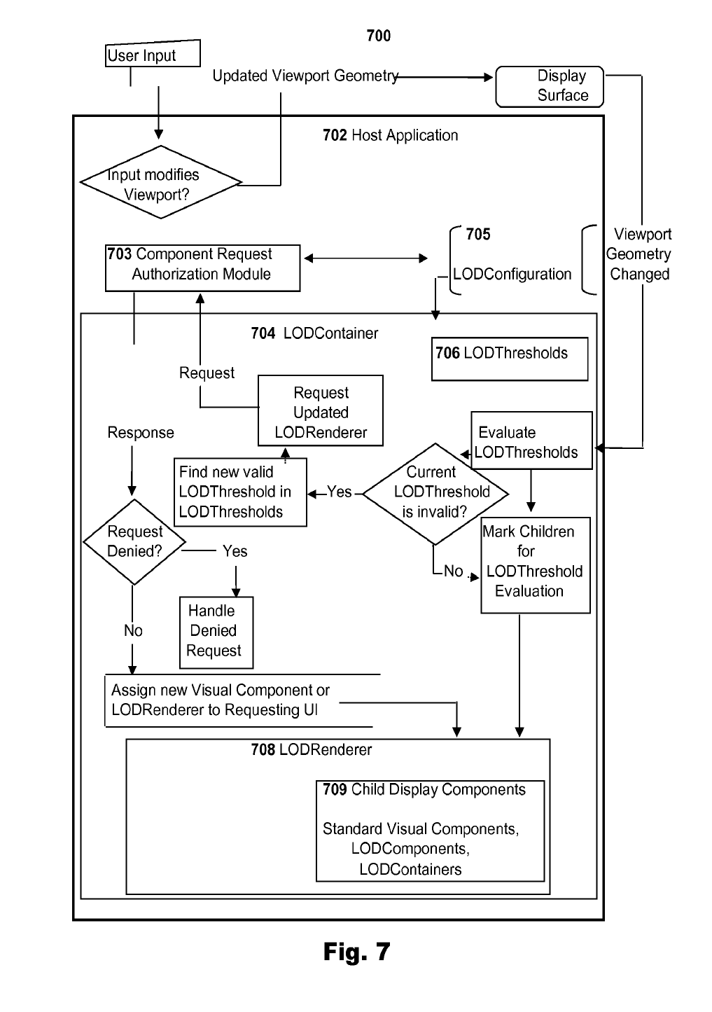

FIG. 7 is a flow chart depicting the LoD System progression in response to user requests.
1. A DOM is loaded into memory, and a top level LODContainer (704) is created and displayed on screen.
2. For each node in the DOM, an LODComponent (709) is created and stored in memory.
3. For each LODComponent (709), both a DOM node and a LODConfiguration (705) are assigned.
4. The top level LODContainer (704) informs the child LODComponents (709) of said LODContainer (704) of their current on screen dimensions, and invalidates their current visual state.
5. The LODComponents (709) examine their associated LODConfiguration (705) in response to invalidation of their current visual state, and determine the first LOD object whose LODThreshold (706) minimum is less than or equal to the current geometry of the object, and whose maximum is greater than the current geometry of the object. The LODComponent (709) then transmits a message to the host Application (702) requesting the correct visual component for the discovered LOD object.
6. The host application (702) examines the requests received from LODComponents (709), and if they are determined to be valid and authentic (703), instances a new object of the visual component requested by the LODComponent (709). This instance is returned to the requesting LODComponent (709). In at least some embodiments, authenticity is determined by shared keys, or keys issued to third party developers, or keys issued via a remote authentication process.
7. Each LODComponent (709) receives a reply from the host application, which, in at least some embodiments, contains a new UI component for display, or an error message describing the reason the request was denied. If the LODComponent (709) receives a new UI component for display, the LODComponent (709) assigns the associated DOM node as data for the UI Component, and transitions the new UI Component to a visible state. Based on the LODComponents' (709) rendererCreationPolicy, the old UI component is either destroyed, or retained in memory for reuse.
8. The user manipulates the current view by panning, zooming, and/or rotating the current view.
   9. The LODContainer (704) responds to the manipulation by returning to step 4 above, and the process is repeated.

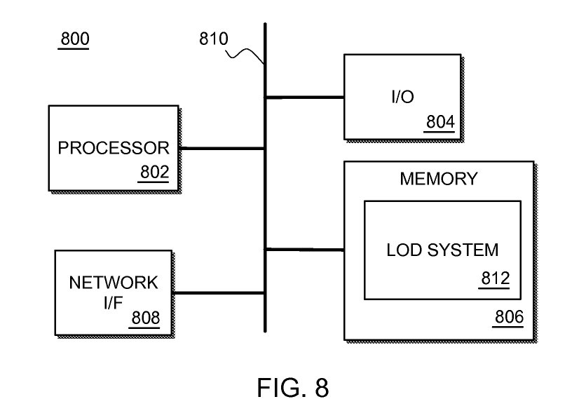

FIG. 8 depicts a high-level functional block diagram of a computer system 800 usable in conjunction with an embodiment. Computer system 800 comprises a processor 802 (alternatively referred to as a processing or controller-based device), a memory 806, a network interface (I/F) 808, and an input/output device 804 communicatively coupled via a bus 810 or other interconnection communication mechanism.

Memory 806 (also referred to as a computer-readable medium) may comprise a random access memory (RAM) or other dynamic storage device, coupled to the bus 810 for storing data and/or instructions to be executed by processor 802. Memory 806 also may be used for storing temporary variables or other intermediate information during execution of instructions to be executed by processor 802. Memory 806 may also comprise a read only memory (ROM) or other static storage device coupled to the bus 810 for storing static information and instructions for the processor 802.

In at least some embodiments, memory 806 also stores a set of executable or interpretable instructions, e.g., dynamic zoom/pan function 812, which, when executed or interpreted by the processor, cause the processor to perform a method according to an embodiment of the invention. In at least some embodiments, execution by processor 802 of the executable instructions causes the display of a user interface to a user of computer system 800 either via I/O device 804 or network I/F 808.

Network I/F 808 comprises a mechanism for connecting to a network. In at least some embodiments, computer system 800 comprises more than a single network interface. In at least some embodiments, network I/F 808 may comprise a wired and/or wireless connection mechanism.

A storage device, such as a magnetic disk, optical disk, or electromagnetic disk, may also be provided and coupled to the bus 810 for storing data and/or instructions.

I/O device 804 may comprise an input device, an output device and/or a combined input/output device for enabling user interaction. An input device may comprise, for example, a keyboard, keypad, mouse, trackball, trackpad, and/or cursor direction keys for communicating information and commands to processor 802. An output device may comprise, for example, a display, a printer, a voice synthesizer, etc. for communicating information to a user. In at least some embodiments, I/O device 804 may comprise a serial and/or parallel connection mechanism for enabling the transfer of one or more of files and/or commands. In at least some embodiments, I/O device 804 is an optional component of computer system 800.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A method of providing at least one user interface control within a Graphical User Interface (GUI) at a variety of zoom depth levels by associating each level of detail with a user interface control; and whereby each user interface control is resizable and/or repositionable with respect to one or more dimensions.

2. An article of manufacture comprising a system and apparatus for providing for providing at least one user interface control within a Graphical User Interface (GUI) at a variety of zoom depth levels by associating each level of detail with a user interface control; and, whereby each user interface control can be resized and/or repositioned to any dimension.
